(19) United States
(12) Patent Application Publication
(10) Pub. No.: US 2009/0185311 A1
(43) Pub. Date: Jul. 23, 2009

(54) MULTIPLE ACCESS HARD DISK

(75) Inventor: Chris (Kyung-Hyun) Kim, Vancouver (CA)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 12/039,769

(22) Filed: Feb. 29, 2008

Related U.S. Application Data
(60) Provisional application No. 61/022,167, filed on Jan. 18, 2008.

(51) Int. Cl. G11B 5/012

(52) U.S. Cl. 360/98.01; 360/97.01

(57) ABSTRACT

Multiple access hard disk. Multiple read-write heads are implemented within a single information storage device. The information storage device can be any of a variety of information storage devices including a hard disk drive (HDD), a CD-ROM (Compact Disc Read Only Memory) drive, a DVD (Digital Video Disc or Digital Versatile Disc) drive, a read-write capable CD (Compact Disc) drive, or a read-write capable DVD drive. Each read-write head may couple to a separate user (or separate device, and/or separate network). Alternatively, more than one of the read-write heads may couple to a single user (or single device, and/or single network). The manner in which each of these read-write heads may be implemented within the information storage device can be varied. If desired, the read-write heads can be arranged in a spoke-like arrangement around a circumference of a circular, spin-capable storage media.

### CROSS REFERENCE TO RELATED PATENTS/PATENT APPLICATIONS

### Provisional Priority Claims

The present U.S. Utility patent application claims priority pursuant to 35 U.S.C. § 119(e) to the following U.S. Provisional Patent Application which is hereby incorporated herein by reference in its entirety and made part of the present U.S. Utility patent application for all purposes:

1. U.S. Provisional Application Ser. No. 61/022,167, entitled “Multiple access hard disk,” (Attorney Docket No. BP6821), filed Jan. 18, 2008, pending.

### BACKGROUND OF THE INVENTION

1. Technical Field of the Invention

The invention relates generally to hard disk drives (HDDs); and, more particularly, it relates to means by which information is written to and read from such HDDs.

2. Description of Related Art

As is known, many varieties of memory storage devices (e.g. hard disk drives (HDDs)), such as magnetic disk drives are used to provide data storage for a host device, either directly, or through a network such as a storage area network (SAN) or network attached storage (NAS). Such a memory storage system (e.g., a HDD) can itself be viewed as a communication system in which information is encoded and provided via a communication channel to a storage media; the reverse direction of communication is also performed in a HDD in which data is read from the media and passed through the communication channel (e.g., sometimes referred to as a read channel in the HDD context) at which point it is typically decoded to makes estimates of the information that is read.

Typical host devices include stand alone computer systems such as a desktop or laptop computer, enterprise storage devices such as servers, storage arrays such as a redundant array of independent disks (RAID) arrays, storage routers, storage switches and storage directors, and other consumer devices such as video game systems and digital video recorders. These devices provide high storage capacity in a cost effective manner.

There continues to be development in the HDD context and within communication devices that includes such HDDs. In such HDD development, one of the driving design parameters is the cost of the read-write arm (sometimes also alternatively referred to as the pick-up arm assembly). Within the art, there is generally a movement to try to decrease the complexity and cost of this portion of a HDD. Generally speaking, this points directly to eliminating any redundancy with respect to the read-write arm in an effort to reduce overall cost of a device that includes an HDD.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 illustrates an embodiment of a multiple read-write head disk drive unit.

FIG. 2 illustrates an embodiment of an apparatus that includes a disk controller.

FIG. 3A illustrates an embodiment of a handheld audio unit.

FIG. 3B illustrates an embodiment of a computer.

FIG. 3C illustrates an embodiment of a wireless communication device.

FIG. 3D illustrates an embodiment of a personal digital assistant (PDA).

FIG. 3E illustrates an embodiment of a laptop computer.

FIG. 4 illustrates an embodiment of a communication system.

FIG. 5 illustrates an embodiment of an apparatus that includes capability to perform information storage.

FIG. 6 illustrates an embodiment of an apparatus that includes capability to perform information storage.

FIG. 7 illustrates an alternative embodiment of a multiple read-write head disk drive unit such that each read-write head couples to a respective user.

FIG. 8 illustrates an alternative embodiment of a multiple read-write head disk drive unit that includes multiple platters or discs.

FIG. 9 illustrates an embodiment of access state transitions in accordance with an access conflict protection for a multiple read-write head disk drive unit.

FIG. 10 illustrates an embodiment of a method for performing access conflict protection.

FIG. 11 illustrates an embodiment of a method for operating an information storage device.

### DETAILED DESCRIPTION OF THE INVENTION

A novel means is presented herein in which multiple read-write heads are implemented within a single information storage device. The information storage device can be any of a variety of information storage devices including a hard disk drive (HDD), a CD-ROM (Compact Disc Read Only Memory) drive, a DVD (Digital Video Disc or Digital Versatile Disc) drive, a read-write capable CD (Compact Disc) drive, or a read-write capable DVD drive. Each read-write head may couple to a separate user (or separate device, and/or separate network). Alternatively, more than one of the read-write heads may couple to a single user (or single device, and/or single network). The manner in which each of these read-write heads may be implemented within the information storage device can be varied. If desired, the read-write heads can be arranged in a spoke-like arrangement around a circumference of a circular, spin-capable information storage media.

One possible embodiment of an information storage device is that of a hard disk drive (HDD). Generally speaking, a basic make up of a HDD drive consists of a spinning, magnetic storage disks sometimes alternatively referred to as platters, a swinging pick-up arm assembly that includes with read-write head, and an electronic circuitry (e.g., a disk controller) that controls reading and writing or information from and to one or more of the platters.

The configuration and assembly of existing HDDs is such that only single user can access the HDD at a given time. Herein, a novel design is presented by which two or more users can simultaneously read and/or write to/from the HDD.

An HDD-based embodiment employing this novel design includes the following:

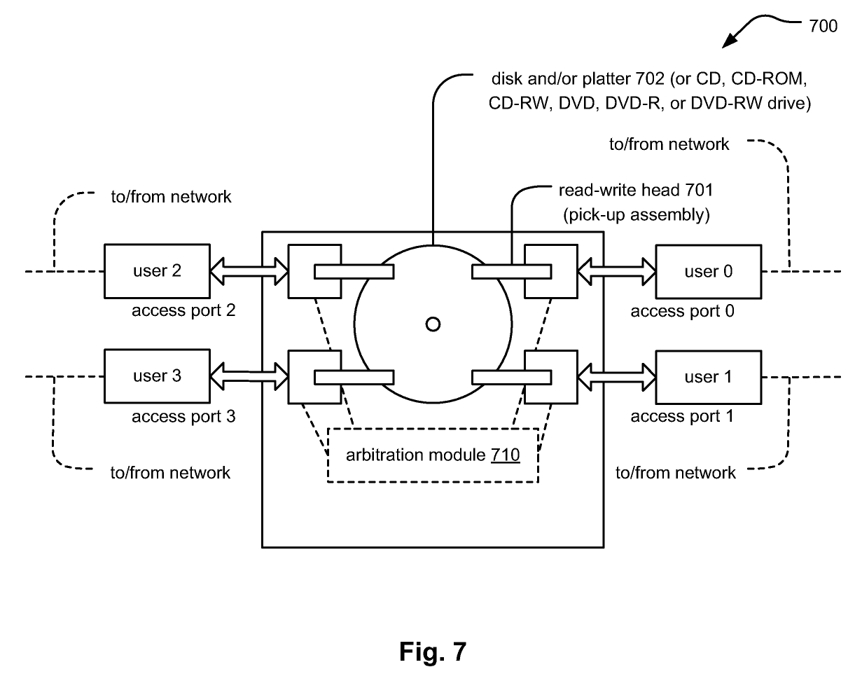

1. The new HDD assembly includes of multiple pick-up arms (e.g., 4 in one embodiment) placed around a circumference of the platters. For example, in an embodiment that includes 4 read-write heads, the 4 read-write heads are implemented at each of the four corners of the rectangular housing (e.g., as depicted in FIG. 7). Each pick-up arm is controlled independently.

2. The new HDD includes multiple interface ports (e.g., 4 in one embodiment) such as (ATA, SATA, SCSI and etc.). Again, the embodiment of FIG. 7 shows 4 read-write heads and 4 corresponding interface ports.

3. The new HDD provides for access conflict protection when more than one of the read-write heads attempts to read and/or write to/from the HDD during a given time period. This protection mechanism prevents any accidental simultaneous read/write of same clusters by multiple accesses. Any access must reserve the required clusters by reserving/locking them first. This cluster locking is done serially and is guarded by semaphore. Each access to the File Allocation Table (FAT) is guarded by semaphore and all the accesses must get hold of File Allocation Table Access Semaphore (FATAS) before any reading/writing can take place by that particular read-write head. The semaphore may be obtained by the First-come-First-served basis. Other means may be employed to govern arbitration including: round robin, random, and/or prioritized means of obtaining the semaphore.

Some background information of a FAT system is provided here, some general information of which is also available via the on-line WIKIPEDIA reference under the subject title of “File Allocation Table”.

Generally speaking, a FAT file system may be viewed as being composed of four different sections indicated as follows:

1. The Reserved sectors, located at the very beginning. The first reserved sector is the Boot Sector (aka Partition Boot Record). It includes an area called the BIOS Parameter Block (with some basic file system information, in particular its type, and pointers to the location of the other sections) and usually contains the operating system's boot loader code. The total count of reserved sectors is indicated by a field inside the Boot Sector. Important information from the Boot Sector is accessible through an operating system structure called the Drive Parameter Block in DOS and OS/2. For FAT32 file systems, the reserved sectors include a Backup Boot Sector at Sector 6.

2. The FAT Region. This typically contains two copies (may vary) of the File Allocation Table for the sake of redundancy checking, although the extra copy is rarely used, even by disk repair utilities. These are maps of the Data Region, indicating which clusters are used by files and directories.

3. The Root Directory Region. This is a Directory Table that stores information about the files and directories located in the root directory. It is only used with FAT12 and FAT16 and means that the root directory has a fixed maximum size which is pre-allocated at creation of this volume. FAT32 stores the root directory in the Data Region along with files and other directories instead, allowing it to grow without such a restraint.

4. The Data Region. This is where the actual file and directory data is stored and takes up most of the partition. The size of files and subdirectories can be increased arbitrarily (as long as there are free clusters) by simply adding more links to the file's chain in the FAT. Note however, that clusters are allocated in their entirety, and so if a 1 KB file resides in a 32 KB cluster, 31 KB are wasted.

Keeping this background information of a FAT system that is referred to above in mind, the File Allocation Table Access Semaphore (FATAS), as described herein in accordance with a novel apparatus including a multiple access hard disk, should be located in the “Reserved Sector” (e.g., as described above). It could be either pre-pended or appended to the “Boot Sector” (e.g., as described above).

In the FAT, cluster locking is then realized by writing a unique “magic” number whenever writing is intended as follows:

a. for locking unused clusters, 32 bit “magic” number.

b. for locking used clusters, write “magic” number (2 bits) to the upper most significant 2 bits of the 32 bit “magic” number referred to in ‘a.’ just above.

It is then noted that for unlocking the clusters, it is not necessary to obtain the File Allocation Table Access Semaphore (FATAS). Rather, it simply erases the “magic” number (2 bits) of the referred to in ‘b.’ just above.

It is also noted that since the reserving cluster takes up little time, the wait period for semaphore is also negligible so that the read/write is still true multiple access, despite the serial and controlled access to the FAT.

Again, it is noted that there are different ways that the independent pick-up arms (read-write heads) maybe placed around the platter. For example, instead of swinging movement, each read-write head may alternatively be mounted on a rail and slid in and out in a radial manner. For example, the rails may be placed/implemented in an analogous manner to the spokes of a bicycle wheel (e.g., approximately evenly distributed around a circumference of the platter, and extending from the edges of the platter towards the center of the platter). Such a spoke-like arrangement would most likely be able accommodate more than four pickup arms/read-write heads (e.g., a 4 read-write head embodiment is depicted herein).

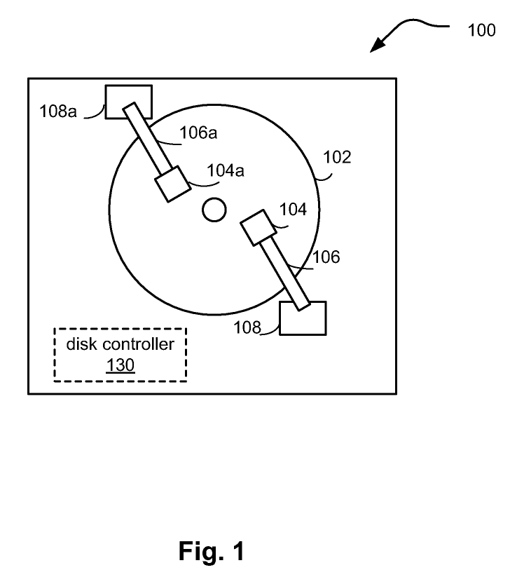

FIG. 1 illustrates an embodiment of a multiple read-write head disk drive unit 100. In particular, disk drive unit 100 includes a disk 102 that is rotated by a servo motor (not specifically shown) at a velocity such as 3600 revolutions per minute (RPM), 4200 RPM, 4800 RPM, 5,400 RPM, 7,200 RPM, 10,000 RPM, 15,000 RPM; however, other velocities including greater or lesser velocities may likewise be used, depending on the particular application and implementation in a host device. In one possible embodiment, disk 102 can be a magnetic disk that stores information as magnetic field changes on some type of magnetic medium. The medium can be a rigid or non-rigid, removable or non-removable, that consists of or is coated with magnetic material.

Disk drive unit 100 further includes one or more read/write shown as read-write head 104 and read-write head 104a that are coupled to arm 106 and arm 106a, respectively, and that are moved by actuator 108 and actuator 108a, respectively, over the surface of the disk 102 either by translation, rotation or both. Two read-write heads are depicted in this embodiment, though it is noted that other embodiments can include more than two read-write heads, and can be generally arranged in various arrangements (e.g., one arrangement includes in a spoke-like arrangement around the circumference of the disk and/or platter of the disk drive unit 100). A disk controller 130 is included for controlling the read and write operations to and from the drive, for controlling the speed of the servo motor and the motion of actuators 108 and 108a, respectively, and for providing an interface to and from the host device.

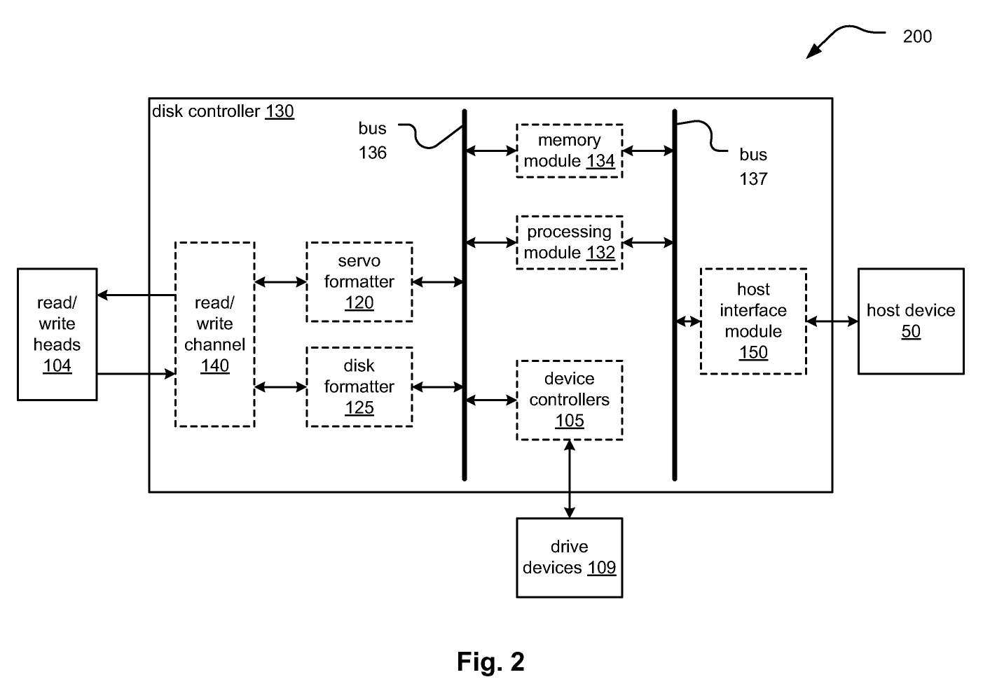

FIG. 2 illustrates an embodiment of an apparatus 200 that includes a disk controller 130. In particular, disk controller 130 includes a read/write channel 140 for reading and writing data to and from disk 102 through read/write heads 104. Disk formatter 125 is included for controlling the formatting of data and provides clock signals and other timing signals that control the flow of the data written to, and data read from disk 102. Servo formatter 120 provides clock signals and other timing signals based on servo control data read from disk 102. Device controllers 105 control the operation of drive devices 109 such as actuator 108 and the servo motor, etc. Host interface 150 receives read and write commands from host device 50 and transmits data read from disk 102 along with other control information in accordance with a host interface protocol. In one embodiment, the host interface protocol can include, SCSI, SATA, enhanced integrated drive electronics (EIDE), or any number of other host interface protocols, either open or proprietary that can be used for this purpose.

Disk controller 130 further includes a processing module 132 and memory module 134. Processing module 132 can be implemented using one or more microprocessors, micro-controllers, digital signal processors, microcomputers, central processing units, field programmable gate arrays, programmable logic devices, state machines, logic circuits, analog circuits, digital circuits, and/or any devices that manipulates signal (analog and/or digital) based on operational instructions that are stored in memory module 134. When processing module 132 is implemented with two or more devices, each device can perform the same steps, processes or functions in order to provide fault tolerance or redundancy. Alternatively, the function, steps and processes performed by processing module 132 can be split between different devices to provide greater computational speed and/or efficiency.

Memory module 134 may be a single memory device or a plurality of memory devices. Such a memory device may be a read-only memory, random access memory, volatile memory, non-volatile memory, static random access memory (SRAM), dynamic random access memory (DRAM), flash memory, cache memory, and/or any device that stores digital information. Note that when the processing module 132 implements one or more of its functions via a state machine, analog circuitry, digital circuitry, and/or logic circuitry, the memory module 134 storing the corresponding operational instructions may be embedded within, or external to, the circuitry comprising the state machine, analog circuitry, digital circuitry, and/or logic circuitry. Further note that, the memory module 134 stores, and the processing module 132 executes, operational instructions that can correspond to one or more of the steps or a process, method and/or function illustrated herein.

Disk controller 130 includes a plurality of modules, in particular, device controllers 105, processing module 132, memory module 134, read/write channel 140, disk formatter 125, and servo formatter 120 that are interconnected via bus 136 and bus 137. The host interface 150 can be connected to only the bus 137 and communicates with the host device 50. Each of these modules can be implemented in hardware, firmware, software or a combination thereof, in accordance with the broad scope of the present invention. While a particular bus architecture is shown in FIG. 2 with buses 136 and 137, alternative bus architectures that include either a single bus configuration or additional data buses, further connectivity, such as direct connectivity between the various modules, are likewise possible to implement the features and functions included in various embodiments.

In one possible embodiment, one or more modules of disk controller 130 are implemented as part of a system on a chip (SoC) integrated circuit. In an embodiment, this SoC integrated circuit includes a digital portion that can include additional modules such as protocol converters, linear block code encoding and decoding modules, etc., and an analog portion that includes device controllers 105 and optionally additional modules, such as a power supply, etc. In a further embodiment, the various functions and features of disk controller 130 are implemented in a plurality of integrated circuit devices that communicate and combine to perform the functionality of disk controller 130.

When the drive unit 100 is manufactured, disk formatter 125 writes a plurality of servo wedges along with a corresponding plurality of servo address marks at equal radial distance along the disk 102. The servo address marks are used by the timing generator for triggering the “start time” for various events employed when accessing the media of the disk 102 through read/write heads 104.

It is noted that certain embodiments include multiple instantiations of disk controllers 130, each one being coupled to a singular, respective read/write head 104; in such an embodiment, the multiple disk controllers 130 includes capability to cooperate with one another to perform arbitration between read/write access conflicts of the multiple read/write heads 104. Alternatively, certain embodiments include a single disk controller 130 that is coupled to multiple read/write heads 104; in such an embodiment, such a single disk controller 130 includes capability to perform arbitration between read/write access conflicts of the multiple read/write heads 104.

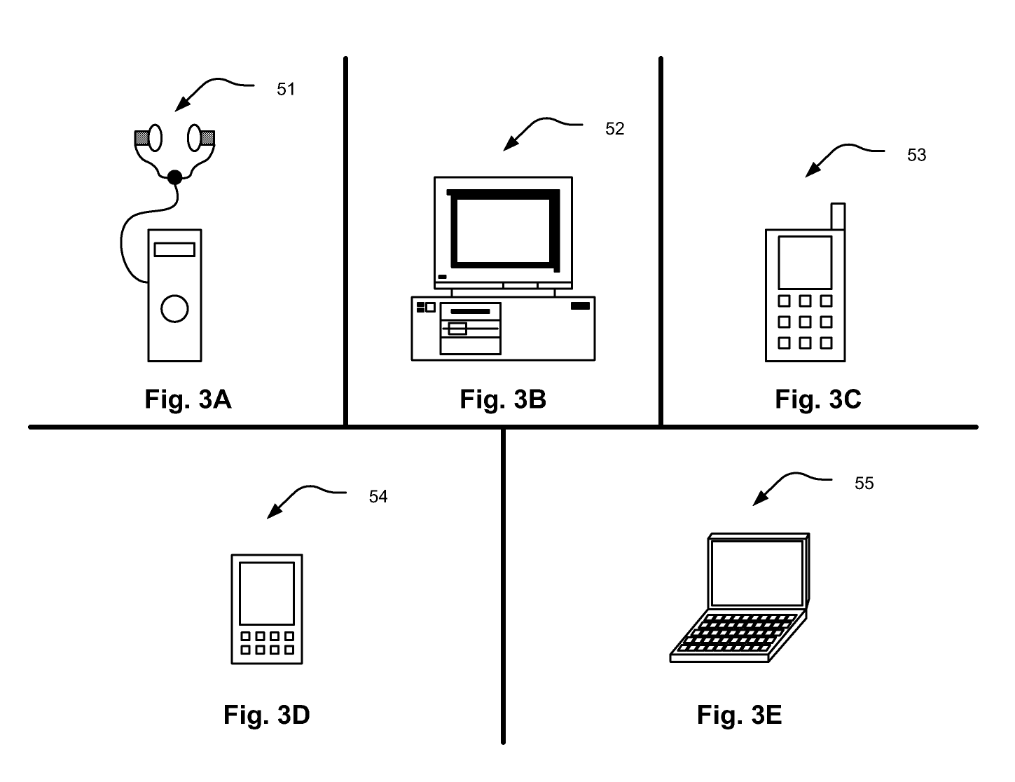

FIG. 3A illustrates an embodiment of a handheld audio unit 51. In particular, disk drive unit 100 can be implemented in the handheld audio unit 51. In one possible embodiment, the disk drive unit 100 can include a small form factor magnetic hard disk whose disk 102 has a diameter 1.8″ or smaller that is incorporated into or otherwise used by handheld audio unit 51 to provide general storage or storage of audio content such as motion picture expert group (MPEG) audio layer 3 (MP3) files or Windows Media Architecture (WMA) files, video content such as MPEG4 files for playback to a user, and/or any other type of information that may be stored in a digital format.

FIG. 3B illustrates an embodiment of a computer 52. In particular, disk drive unit 100 can be implemented in the computer 52. In one possible embodiment, disk drive unit 100 can include a small form factor magnetic hard disk whose disk 102 has a diameter 1.8″ or smaller, a 2.5″ or 3.5″ drive or larger drive for applications such as enterprise storage applications. Disk drive 100 is incorporated into or otherwise used by computer 52 to provide general purpose storage for any type of information in digital format. Computer 52 can be a desktop computer, or an enterprise storage devices such a server, of a host computer that is attached to a storage array such as a redundant array of independent disks (RAID) array, storage router, edge router, storage switch and/or storage director.

FIG. 3C illustrates an embodiment of a wireless communication device 53. In particular, disk drive unit 100 can be implemented in the wireless communication device 53. In one possible embodiment, disk drive unit 100 can include a small form factor magnetic hard disk whose disk 102 has a diameter 1.8″ or smaller that is incorporated into or otherwise used by wireless communication device 53 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats that may be captured by an integrated camera or downloaded to the wireless communication device 53, emails, webpage information and other information downloaded from the Internet, address book information, and/or any other type of information that may be stored in a digital format.

In a possible embodiment, wireless communication device 53 is capable of communicating via a wireless telephone network such as a cellular, personal communications service (PCS), general packet radio service (GPRS), global system for mobile communications (GSM), and integrated digital enhanced network (iDEN) or other wireless communications network capable of sending and receiving telephone calls. Further, wireless communication device 53 is capable of communicating via the Internet to access email, download content, access websites, and provide steaming audio and/or video programming. In this fashion, wireless communication device 53 can place and receive telephone calls, text messages such as emails, short message service (SMS) messages, pages and other data messages that can include attachments such as documents, audio files, video files, images and other graphics.

FIG. 3D illustrates an embodiment of a personal digital assistant (PDA) 54. In particular, disk drive unit 100 can be implemented in the personal digital assistant (PDA) 54. In one possible embodiment, disk drive unit 100 can include a small form factor magnetic hard disk whose disk 102 has a diameter 1.8″ or smaller that is incorporated into or otherwise used by personal digital assistant 54 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats, emails, webpage information and other information downloaded from the Internet, address book information, and/or any other type of information that may be stored in a digital format.

FIG. 3E illustrates an embodiment of a laptop computer 55. In particular, disk drive unit 100 can be implemented in the laptop computer 55. In one possible embodiment, disk drive unit 100 can include a small form factor magnetic hard disk whose disk 102 has a diameter 1.8″ or smaller, or a 2.5″ drive. Disk drive 100 is incorporated into or otherwise used by laptop computer 52 to provide general purpose storage for any type of information in digital format.

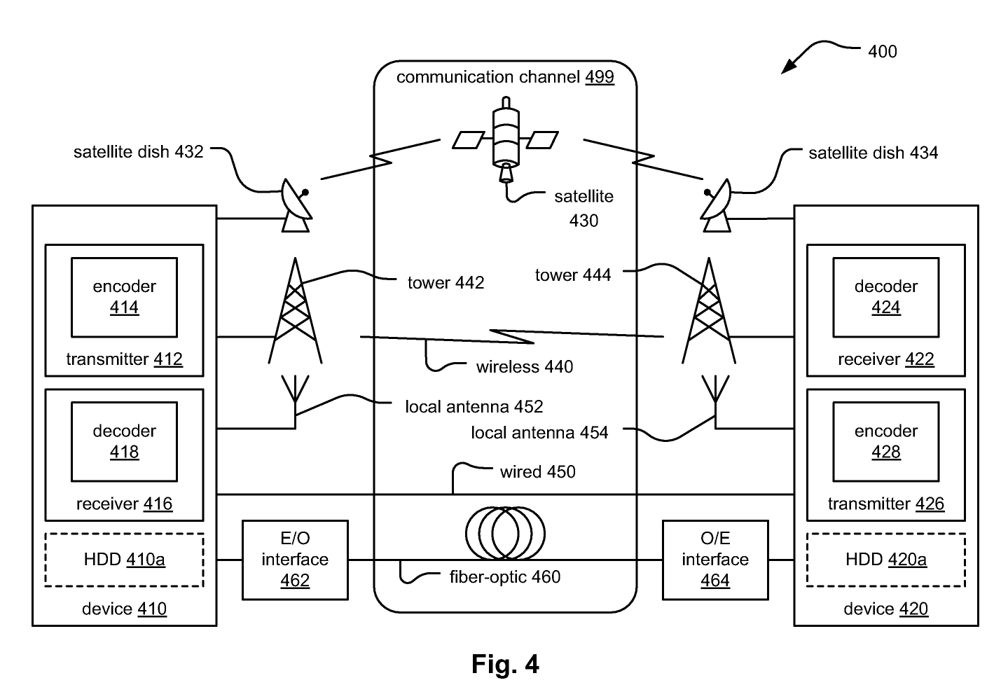

The goal of digital communications systems is to transmit digital data from one location, or subsystem, to another either error free or with an acceptably low error rate. As shown in FIG. 4, data may be transmitted over a variety of communications channels in a wide variety of communication systems: magnetic media, wired, wireless, fiber, copper, and other types of media as well.

FIG. 4 is a diagram illustrating an embodiment of a communication system 400.

Referring to FIG. 4, this embodiment of a communication system 400 is a communication channel 499 that communicatively couples a communication device 410 (including a transmitter 412 having an encoder 414 and including a receiver 416 having a decoder 418) situated at one end of the communication channel 499 to another communication device 420 (including a transmitter 426 having an encoder 428 and including a receiver 422 having a decoder 424) at the other end of the communication channel 499. In some embodiments, either of the communication devices 410 and 420 may only include a transmitter or a receiver. There are several different types of media by which the communication channel 499 may be implemented (e.g., a satellite communication channel 430 using satellite dishes 432 and 434, a wireless communication channel 440 using towers 442 and 444 and/or local antennae 452 and 454, a wired communication channel 450, and/or a fiber-optic communication channel 460 using electrical to optical (E/O) interface 462 and optical to electrical (O/E) interface 464)). In addition, more than one type of media may be implemented and interfaced together thereby forming the communication channel 499.

Either one of both of the communication device 410 and the communication device 420 can include a hard disk drive (HDD) (or be coupled to a HDD) that includes two or more read-write heads. For example, the communication device 410 can include a HDD 410a that includes two or more read-write heads, and the communication device 420 can include a HDD 420a that includes two or more read-write heads.

The signals employed within this embodiment of a communication system 400 can be Reed-Solomon (RS) coded signals, LDPC (Low Density Parity Check) coded signal, turbo coded signals, turbo trellis coded modulation (TTCM), or coded signal generated using some other error correction code (ECC). Alternatively, uncoded modulation may be employed herein as well without departing from the scope and spirit of the invention.

Any of a very wide variety of applications that perform transferring of data from one location to another (e.g., including from a first location to a HDD, or from the HDD to another location) can benefit from various aspects of the invention, including any of those types of communication devices and/or communication systems depicted in FIG. 4. Moreover, other types of devices and applications that perform storage of information and/or accessing of stored information (e.g., including those employing some type of HDD or other memory storage means) can also benefit from various aspects of the invention.

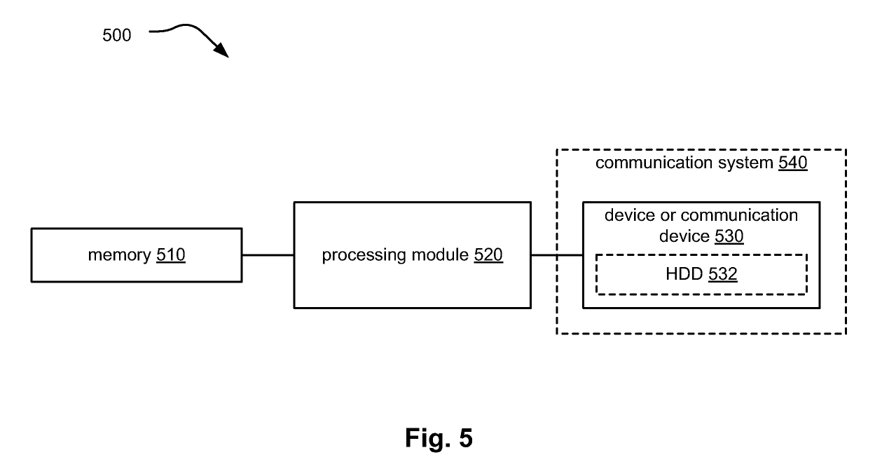

FIG. 5 illustrates an embodiment of an apparatus 500 that includes capability to perform information storage. The apparatus 500 includes a processing module 520, and a memory 510. The memory 510 is coupled to the processing module, and the memory 510 is operable to store operational instructions that enable the processing module 520 to perform a variety of functions. The processing module 520 is operable to perform and/or direct reading and/or writing of information to a HDD 532 implemented within a device or communication device 530. Such an HDD 532 may be implemented with multiple read-write heads in accordance with the various aspects presented herein.

The processing module 520 can be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 510 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 520 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

If desired in some embodiments, the means of reading and/or writing information to and/or from the HDD 532 can be provided from the apparatus 500 to a communication system 540. The means of reading and/or writing information to and/or from the HDD 532 can also be provided from the apparatus 500 to any of a variety of devices or communication devices 530 implemented within the communication system 540 as well. The device or communication device 530 itself includes the HDD 532 in this embodiment. This way, a completely integrated means is provided by which the means of reading and/or writing information to and/or from the HDD 532 is implemented as part of a device or communication device 530 that includes the HDD 532.

If desired, the apparatus 520 can be designed to perform different means of performing reading and/or writing information to and/or from the HDD 532 corresponding to multiple needs and/or desires as well. In some embodiments, the apparatus 520 can selectively provide such different information (corresponding to different means of reading and/or writing information to and/or from the HDD 532) to different communication devices and/or communication systems.

Clearly, the apparatus 520 can also provide the same information (corresponding to a singular means of reading and/or writing information to and/or from the HDD 532) to each of different communication devices and/or communication systems as well without departing from the scope and spirit of the invention.

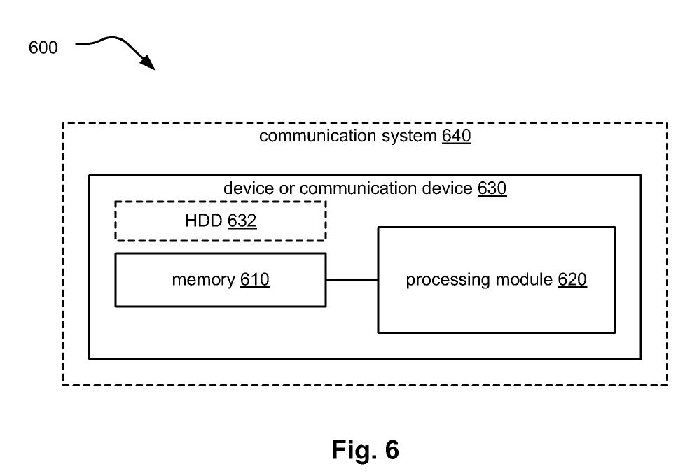

FIG. 6 illustrates an embodiment of an apparatus 600 that includes capability to perform information storage. The apparatus 600 includes a processing module 620, and a memory 610. The memory 610 is coupled to the processing module, and the memory 610 is operable to store operational instructions that enable the processing module 620 to perform a variety of functions. The processing module 620 (serviced by the memory 610) can be implemented as an apparatus capable to perform any of the functionality of any of the various modules and/or functional blocks described herein. For example, the processing module 620 (serviced by the memory 620) can be implemented as an apparatus capable to perform reading and/or writing information to and/or from the HDD 632 using any of the various embodiments described herein.

The processing module 620 can be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 610 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 620 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

If desired in some embodiments, the apparatus 600 can be any of a variety of devices, or any part or portion of any such device or communication device. The device or communication device 630 can include a HDD 632 in certain embodiments. Any such communication device that includes the apparatus 600 can be implemented within any of a variety of communication systems 640 as well. It is also noted that various embodiments of means of reading and/or writing information to and/or from the HDD 632 presented herein, and equivalents thereof, may be applied to many types of communication systems and/or communication devices.

FIG. 7 illustrates an alternative embodiment of a multiple read-write head disk drive unit 700 such that each read-write head couples to a respective user. One or more disks and/or platters 702 are implemented such that multiple read-write heads (alternatively referred to as pick-up assemblies) can read and/or write information to the one or more disks and/or platters 702. One read-write head is depicted using reference numeral 701. Each of these read-write heads can individually access the one or more disks and/or platters 702 at a time. An arbitration module 710 is implemented to arbitrate among access conflicts when more than one of the read-write heads attempts to access a same portion of the one or more disks and/or platters 702 during a common time period.

Each read-write head is coupled to an individual access port that then couples to a respective user. For example, an access port 0 couples read-write head 701 to user 0. Access port 1 couples another read-write head to user 1, access port 2 couples another read-write head to user 2, and access port 3 couples another read-write head to user 3. Each of the users can at least one be coupled to another network (e.g., a local area network (LAN), the Internet, wide area network (WAN), and/or other network).

The arbitration as performed by the arbitration module 710 can be implemented in hardware, in that, access requests are made by each of the user (e.g., via their corresponding read-write head) to the arbitration module 710, and the arbitration module 710 outputs a grant or deny signal to each of the corresponding read-write heads. For example, considering the embodiment of FIG. 7, 4 access request 1-bit lines may provide access request signals to the arbitration module 710. Then, after performing arbitration, the arbitration module 710 outputs 4 separate 1-bit grant or deny signals to the corresponding 4 read-write heads, respectively. This way, appropriate access requests can be appropriately arbitrated using the arbitration module 710.

It is noted that this novel implementation of including multiple read-write heads in a device can be extended and applied to a wide variety of platforms including not only a hard disk drive (HDD), but also to a CD-ROM (Compact Disc Read Only Memory) drive, a DVD (Digital Video Disc or Digital Versatile Disc) drive, a read-write capable CD (Compact Disc) drive, or a read-write capable DVD drive. Generally speaking, any information storage device can benefit from the novel implementation of including multiple read-write heads.

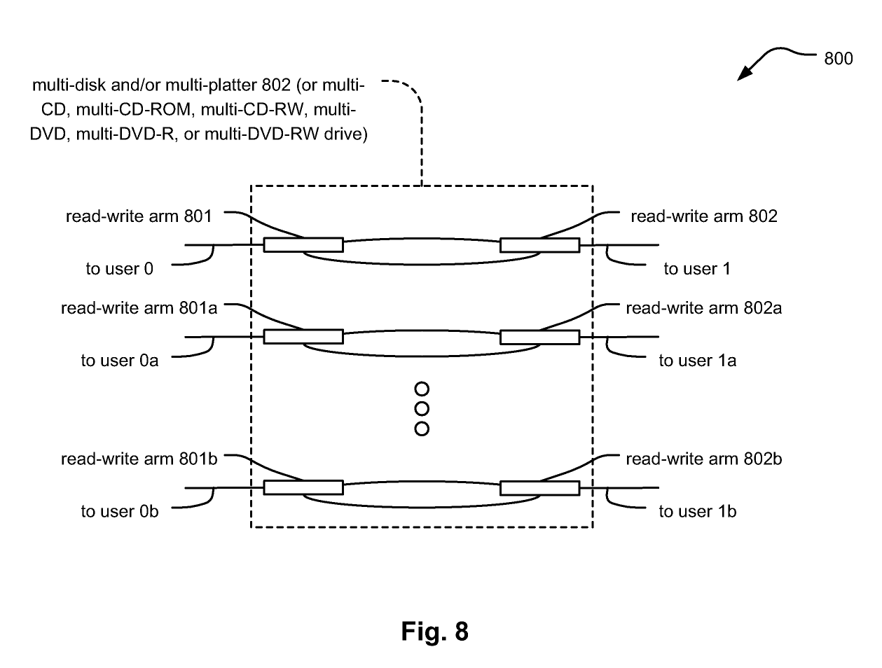

FIG. 8 illustrates an alternative embodiment of a multiple read-write head disk drive unit 800 that includes multiple platters or discs 802. As with previous embodiments, it is noted that the multiple platters or discs 802 in this embodiment can be any one of a number of types of information storage media (e.g., platters of a HDD, CD-ROM, CR-RW, DVD-R, DVD-RW, etc.).

A read-write arm 801 is implemented to read from a first platter and to provide information to/from a user 0. A read-write arm 802 is implemented to read from a first platter and to provide information to/from a user 1. As depicted in the diagram, each of the read-write arms couples to a respective user (e.g., read-write arm 801a to user 0a, read-write arm 802a to user 1a, and so on until read-write arm 801b to user 0b, read-write arm 802b to user 1b).

While many embodiments depicted herein show a read-write type of information storage device, it is noted that these principles of using multiple pick-up assemblies can be applied to devices including multiple read-only type of pick-up assemblies. For example, instead of an information storage device including multi-read-write heads (e.g., multiple read-write heads), an information storage device could alternatively include multi-read-only heads (e.g., multiple read-only heads). Clearly, combinations of some pick-up assemblies having read-write capability and some pick-up assemblies having read-only capability can also be implemented within a given device.

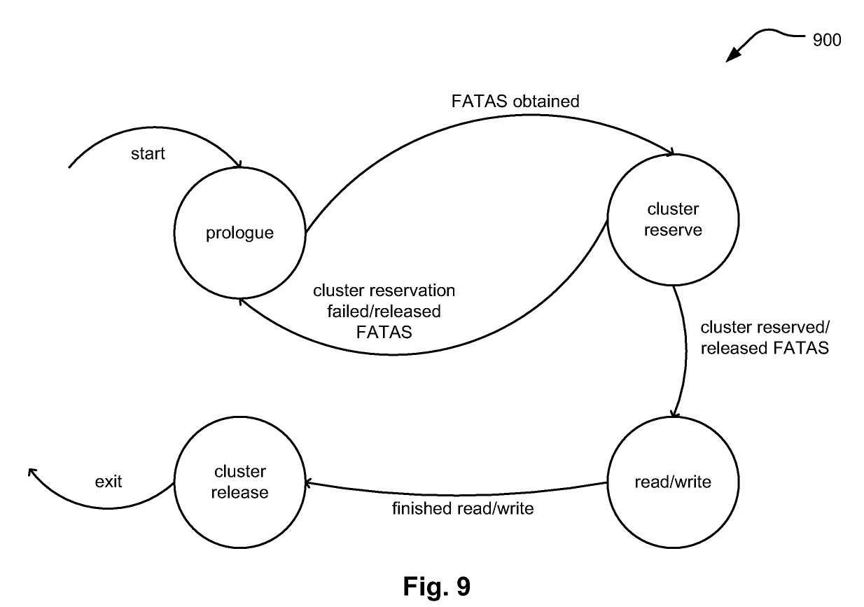

FIG. 9 illustrates an embodiment of access state transitions 900 in accordance with an access conflict protection for a multiple read-write head disk drive unit.

This flow of access state transitions can be described as follows:

STEP 1. Wait till File Allocation Table (FAT) Access Semaphore (FATAS) is available;

STEP 2. If it is ok to reserve free/existing clusters of the required file size,
STEP 2.1 lock them up by setting flag in the appropriate entries of FAT.
STEP 2.2 Goto 4

STEP 3. Else release FATAS and goto 1

STEP 4. Release FATAS and start accessing (read/write) the reserved file or cluster

STEP 5. After finishing read/write, unlock the clusters.

The following table also describes this flow of access state transitions.

| State | Description | Algorithm |
|---|---|---|
| Prologue | waiting for the FATAS | Step 1 |
| Cluster Reserve | Has obtained FATAS and reserve clusters | Step 2 & 3 |
| | if available, otherwise release FATAS | |
| Read/Write | Has successfully reserved clusters and doing | Step 4 |
| | read/write | |
| Cluster Release | Finished read/write and releasing clusters | Step 5 |

It is noted that each independent access (e.g., by a separate and independent read-write head) goes through various resource locking states. This transition mechanism is employed to prevent data corruption from simultaneous access of the same clusters by more than one read-write head.

The use of a semaphore to control access to the storage media ensures there is never any parallel access thereto; all of the access is performed in a serial manner. However, it is noted that the access time with respect to the FAT modification is very, very small when compared to the read and/or write access to the storage media (e.g., as in a HDD application). Therefore, the access is truly simultaneously access.

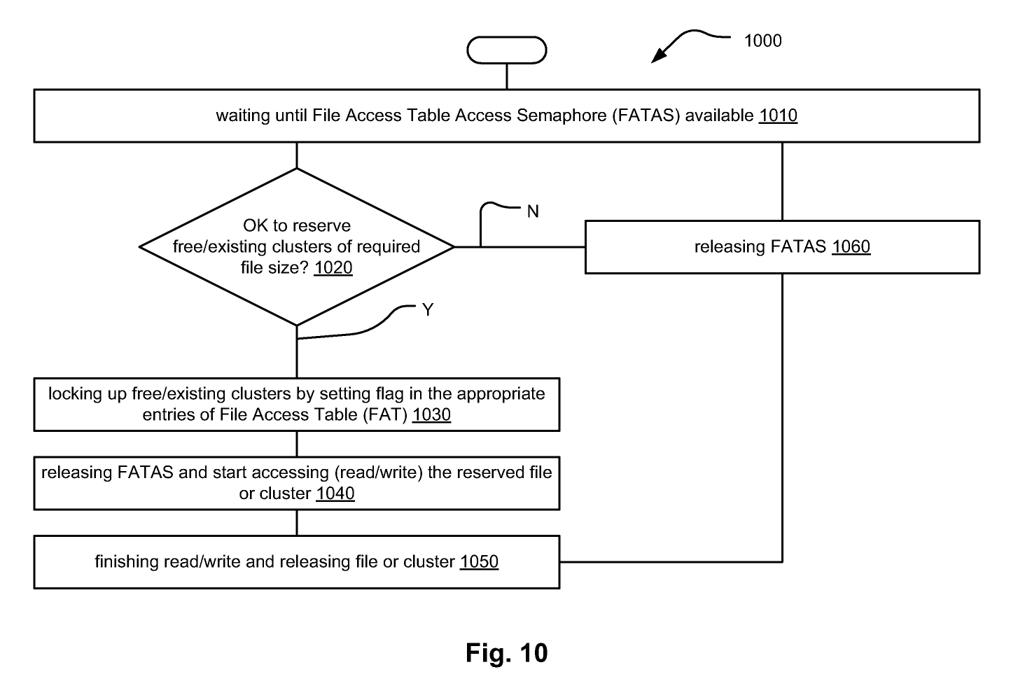

FIG. 10 illustrates an embodiment of a method 1000 for performing access conflict protection. The method 1000 begins by waiting until a File Allocation Table Access Semaphore (FATAS) is available, as shown in a block 1010. Then, as shown in a decision block 1020, the method 1000 continues by determining whether it is OK to reserve free/existing clusters of a required file size. If not, then the method 1000 continues by releasing the FATAS, as shown in a block 1060.

However, if is in fact OK to reserve free/existing clusters of a required file size as determined within the decision block 1020, then the method 1000 continues by locking up free/existing clusters by setting a flag in the appropriate entries of the File Allocation Table (FAT), as shown in a block 1030.

The method 1000 continues by releasing the FATAS and start accessing (read/write) the reserved file or cluster, as shown in a block 1040. The method 1000 continues by finishing the read/write and releasing the file or cluster, as shown in a block 1050. The method 1000 then continues to block 1060.

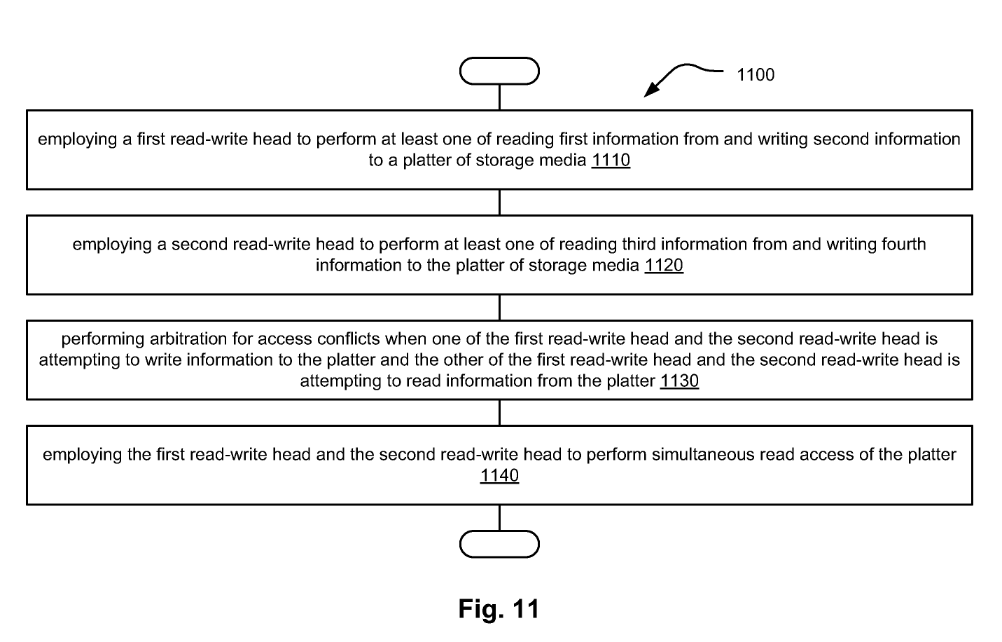

FIG. 11 illustrates an embodiment of a method 1100 for operating an information storage device. The method 1100 begins by employing a first read-write head to perform at least one of reading first information from and writing second information to a platter of storage media, as shown in a block 1110.

The method 1100 continues by employing a second read-write head to perform at least one of reading third information from and writing fourth information to the platter of storage media, as shown in a block 1120.

The method 1100 continues by performing arbitration for access conflicts when one of the first read-write head and the second read-write head is attempting to write information to the platter and the other of the first read-write head and the second read-write head is attempting to read information from the platter, as shown in a block 1130. The method 1100 continues by employing the first read-write head and the second read-write head to perform simultaneous read access of the platter, as shown in a block 1140.

It is noted that the various modules (e.g., encoding modules, decoding modules, processing modules, arbitration modules, etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory. The memory may be a single memory device or a plurality of memory devices. Such a memory device may be a read-only memory, random access memory, volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. An apparatus implemented to perform information storage, the apparatus comprising:
a first read-write head implemented to perform at least one of reading first information from and writing second information to a platter of storage media; and
a second read-write head implemented to perform at least one of reading third information from and writing fourth information to the platter of storage media; and wherein:
the first read-write head and the second read-write head are implemented to perform simultaneous read access of the platter.

2. The apparatus of claim 1, wherein:
the first read-write head and the second read-write head are read-write heads of a plurality of read-write heads implemented as spokes around a circumference of the platter.

3. The apparatus of claim 1, wherein:
the first read-write head is implemented to perform only read of information from the platter of storage media; and
the second read-write head is implemented to perform only read of information from the platter of storage media.

4. The apparatus of claim 1, wherein:
the third information is the first information.

5. The apparatus of claim 1, wherein:
the first read-write head couples to a first user device; and
the second read-write head couples to a second user device.

6. The apparatus of claim 1, wherein:
the first read-write head couples to a user device; and
the second read-write head couples to the user device.

7. The apparatus of claim 1, wherein:
when the first read-write head attempts to read information from a location of the platter during a time period in which the second read-write head attempts to read information from the location of the platter, the first read-write head performs the read before the second read-write head performs the write.

8. The apparatus of claim 1, wherein:
the first read-write head couples to a first user device;
the second read-write head couples to a second user device; and
when during a time period:
the first read-write head attempts to write the second information to the platter and the second read-write head attempts to read the third information from the platter; or
the second read-write head attempts to write the fourth information to the platter and the first read-write head attempts to read the first information from the platter:
the apparatus arbitrates an order by which the first read-write head and the second read-write head perform respective read or write processes.

9. The apparatus of claim 1, wherein:
the apparatus includes a plurality of platters;
the platter is a first platter of the plurality of platters; and further comprising:
a third read-write head implemented to perform at least one of reading fifth information from and writing sixth information to a second platter of the plurality of platters; and
a fourth read-write head implemented to perform at least one of reading seventh information from and writing eighth information to the second platter of the plurality of platters.

10. The apparatus of claim 1, wherein:
the apparatus is a hard disk drive (HDD), a CD-ROM (Compact Disc Read Only Memory) drive, a DVD (Digital Video Disc or Digital Versatile Disc) drive, a read-write capable CD (Compact Disc) drive, or a read-write capable DVD drive.

11. An apparatus implemented to perform information storage, the apparatus comprising:
a first read-write head implemented to perform at least one of reading first information from and writing second information to a platter of storage media;
a second read-write head implemented to perform at least one of reading third information from and writing fourth information to the platter of storage media; and
an arbitration module implemented to arbitrate between access conflicts when one of the first read-write head and the second read-write head attempts to write information to the platter and the other of the first read-write head and the second read-write head attempts to read information from the platter; and wherein:
the first read-write head and the second read-write head are implemented to perform simultaneous read access of the platter.

12. The apparatus of claim 1, wherein:
the first read-write head and the second read-write head are read-write heads of a plurality of read-write heads implemented as spokes around a circumference of the platter.

13. The apparatus of claim 11, wherein:
the first read-write head couples to a first user device; and
the second read-write head couples to a second user device.

14. The apparatus of claim 11, wherein:
the first read-write head couples to a user device; and
the second read-write head couples to the user device.

15. The apparatus of claim 11, wherein:
the apparatus includes a plurality of platters;
the platter is a first platter of the plurality of platters; and further comprising:
a third read-write head implemented to perform at least one of reading fifth information from and writing sixth information to a second platter of the plurality of platters; and
a fourth read-write head implemented to perform at least one of reading seventh information from and writing eighth information to the second platter of the plurality of platters.

16. The apparatus of claim 11, wherein:
the apparatus is a hard disk drive (HDD), a CD-ROM (Compact Disc Read Only Memory) drive, a DVD (Digital Video Disc or Digital Versatile Disc) drive, a read-write capable CD (Compact Disc) drive, or a read-write capable DVD drive.

17. A method for operating an information storage device, the method comprising:
employing a first read-write head to perform at least one of reading first information from and writing second information to a platter of storage media;
employing a second read-write head to perform at least one of reading third information from and writing fourth information to the platter of storage media;
performing arbitration for access conflicts when one of the first read-write head and the second read-write head is attempting to write information to the platter and the other of the first read-write head and the second read-write head is attempting to read information from the platter; and
employing the first read-write head and the second read-write head to perform simultaneous read access of the platter.

18. The method of claim 17, wherein:
the first read-write head couples to a first user device; and
the second read-write head couples to a second user device.

19. The method of claim 17, wherein:
the method is performed within an apparatus;
the apparatus includes a plurality of platters;
the platter is a first platter of the plurality of platters; and further comprising:
employing a third read-write head to perform at least one of reading fifth information from and writing sixth information to a second platter of the plurality of platters; and
employing a fourth read-write head to perform at least one of reading seventh information from and writing eighth information to the second platter of the plurality of platters.

20. The method of claim 17, wherein:
the method is performed within an apparatus; and
the apparatus is a hard disk drive (HDD), a CD-ROM (Compact Disc Read Only Memory) drive, a DVD (Digital Video Disc or Digital Versatile Disc) drive, a read-write capable CD (Compact Disc) drive, or a read-write capable DVD drive.
